(19) United States
(12) Patent Application Publication
(10) Pub. No.: US 2019/0168803 A1
(43) Pub. Date: Jun. 6, 2019

(54) METHOD OF CONTROLLING A VEHICLE IN CASE OF STEERING SYSTEM FAILURE

(71) Applicant: TRW Automotive U.S. LLC, Livonia, MI (US)

(72) Inventors: Joseph D. Miller, Farmington Hills, MI (US); Brian T. Murray, Novi, MI (US)

(21) Appl. No.: 15/832,794

(22) Filed: Dec. 6, 2017

(51) Int. Cl. B62D 5/04; B60W 30/02; B60W 10/184; B60W 10/20

(52) U.S. Cl. CPC B62D 5/0484; B60W 10/20; B60W 10/184; B60W 30/02

(57) ABSTRACT

A method of operating a vehicle to maintain the vehicle along a desired course. The vehicle has a first steering system for turning left and right wheels at a first end of the vehicle, a second steering system for turning left and right wheels at a second end of the vehicle, brakes for slowing rotation of the wheels, and a steering lock mechanism. The method includes determining that the first steering system is malfunctioning. The steering lock mechanism is operated to lock out turning of the left and right wheels at the first end of the vehicle. The brakes are operated to maintain the vehicle along the desired course. The second steering system is operated to maintain the vehicle along the desired course.

### FIELD OF THE INVENTION

The present invention relates to autonomously driven vehicles and, in particular, to a method of controlling an autonomously driven vehicle in case of steering system failure.

### BACKGROUND TO THE INVENTION

The prevalence of vehicles having autonomous driving capabilities is rapidly increasing, if the steering system of a vehicle fails, it is desirable for there to be a backup mechanism that allows the vehicle to maintain a desired course. To this end, autonomously driven vehicles have been provided with a secondary steering system that steers the rear wheels if the primary steering system that steers the front wheels fails.

When the secondary steering system is tasked with maintaining the vehicle on the desired course, it is desirable to lock out the primary steering system (i.e., prevent the front wheels from turning). One way of accomplishing lock out of the primary steering system is by providing a clamping system that, for example, damps a steering shaft associated with the primary steering system. However, it has been found that an autonomously driven vehicle may deviate from a desired course in instances of primary steering system failure during high-g situations (e.g., when the vehicle is navigating a curve) due to lag associated with the damping system.

### SUMMARY OF THE INVENTION

According to one aspect of the invention, a method of operating a vehicle to maintain the vehicle along a desired course is disclosed. The vehicle has a first steering system for turning left and right wheels at a first end of the vehicle, a second steering system for turning left and right wheels at a second end of the vehicle, brakes for slowing rotation of the wheels, and a steering lock mechanism. The method includes determining that the first steering system is malfunctioning. The steering lock mechanism is operated to lock out turning of the left and right wheels at the first end of the vehicle. The brakes are operated to maintain the vehicle along the desired course The second steering system is operated to maintain the vehicle along the desired course.

### BRIEF DESCRIPTION OF THE DRAWINGS

Embodiments of the invention will now be described by way of example only, with reference to the accompanying drawings, in which:

FIG. 1 is a schematic of a vehicle; and

FIG. 2 is a flow chart depicting a method of operating the vehicle of FIG. 1.

### DETAILED DESCRIPTION

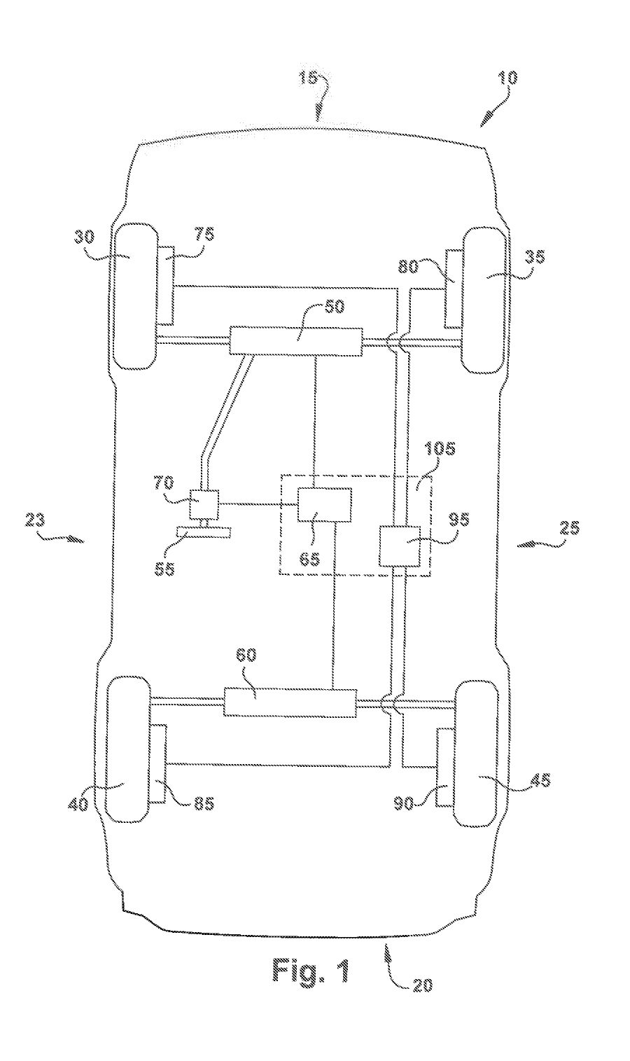

A vehicle 10 having autonomous driving capabilities is shown in FIG. 1. The vehicle 10 has a front 15, a rear 20, a left side 23, and a right side 25. As used in this specification, the front 15 refers to the leading side of the vehicle 10 when the vehicle is traveling in a forward gear. The rear 20 refers to the leading side of the vehicle 10 when the vehicle is traveling in a reverse gear. The left side 23 and the right side 25 are defined with respect to an occupant seated in the vehicle 10 facing the front 15.

The vehicle 10 includes a front left wheel 30, a front right wheel 35, a rear left wheel 40, and a rear right wheel 45. A first steering system 50 is provided for turning the front wheels 30, 35. As used in this specification, turning the wheels refers to adjusting the direction of the wheels so as to effect the direction of travel of the vehicle 10 when the vehicle is traveling in a forward or reverse gear. The first steering system 50 can be controlled by an input device 55 (e.g., steering wheel) that can be manipulated by an operator of the vehicle 10.

A second steering system 60 is provided for turning the rear wheels 40,45. It is contemplated that the second steering system 60 may also be controlled by the Input device 55. A steering controller 65 is in communication with the first steering system 50, the second steering system 60, and the input device 55. The steering controller 65 can monitor operation of the first and second steering systems 50, 60, control operation of the first and second steering systems, and monitor operation of the input device 55. The steering controller 65 is also in communication with a steering lock mechanism 70. The steering lock mechanism 70 is operable to lock out operation of the first steering system 50, thereby preventing turning of the front wheels 40, 45.

A front left brake 75, a front right brake 80, a rear left brake 85, and a rear right brake 90 are provided for slowing rotation of the front left wheel 30, the front right wheel 35, the rear left wheel 40, and the rear right wheel 45, respectively. A brake controller 95 is in communication with the brakes 75, 80, 85, 90. The brake controller 95 can operate the brakes 75, 80, 85, 90 in a vehicle slowing mode and a vehicle turning mode. In the vehicle slowing mode, the brakes 75, 80, 85, 90 are operated primarily to slow forward or reverse travel of the vehicle 10. In vehicle turning mode, the brakes 75, 80, 85, 90 are operated primarily to turn the vehicle 10 to the left or to the right. It is contemplated that the brakes 75, 80, 85, 90 may simultaneously be operated in vehicle slowing mode and vehicle turning mode (i.e., slow forward or reverse travel of the vehicle 10 while also turning the vehicle to the left or the right).

As known by those skilled in the automotive art, the vehicle turning mode of operating the brakes can be referred to as “differential braking”. In differential braking, the front and rear left brakes 75, 85 can be operated to slow rotation of the front and rear left wheels 30, 40, respectively, thereby causing the vehicle 10 to turn to the left. Similarly, the front and rear right brakes 80, 90 can be operated to slow rotation of the front and rear right wheels 35, 45, respectively, thereby causing the vehicle 10 to turn the right, it is contemplated that all the brakes 75, 80, 85, 90 may be operated while still employing differential braking. For example, the front and rear left brakes 75,85 can be applied at a greater level than the front and rear right brakes 80, 90, thereby slowing rotation of the front and rear left wheels 30, 40 more rapidly than rotation of the front and rear right wheels 35, 45, thus causing the vehicle 10 to turn left. As another example, the front and rear right brakes 80, 90 can be applied at a greater level than the front and rear left brakes 75, 85, thereby slowing rotation of the front and rear right wheels 35,45 more rapidly than rotation of the front and rear left wheels 30, 40, thus causing the vehicle 10 to turn right.

The steering controller 65 and the brake controller 95 can be part of an electronic control unit (ECU) 105. The ECU 105 can facilitate communication between, and monitor, the steering controller 65 and the brake controller 95. The ECU 105 can also monitor and/or control other operational aspects of the vehicle 10. For example, the ECU 105 can control the autonomous driving capabilities of the vehicle 10. It is contemplated that the ECU 105 may be omitted and the steering controller 65 and the brake controller 95 be in direct communication with one another.

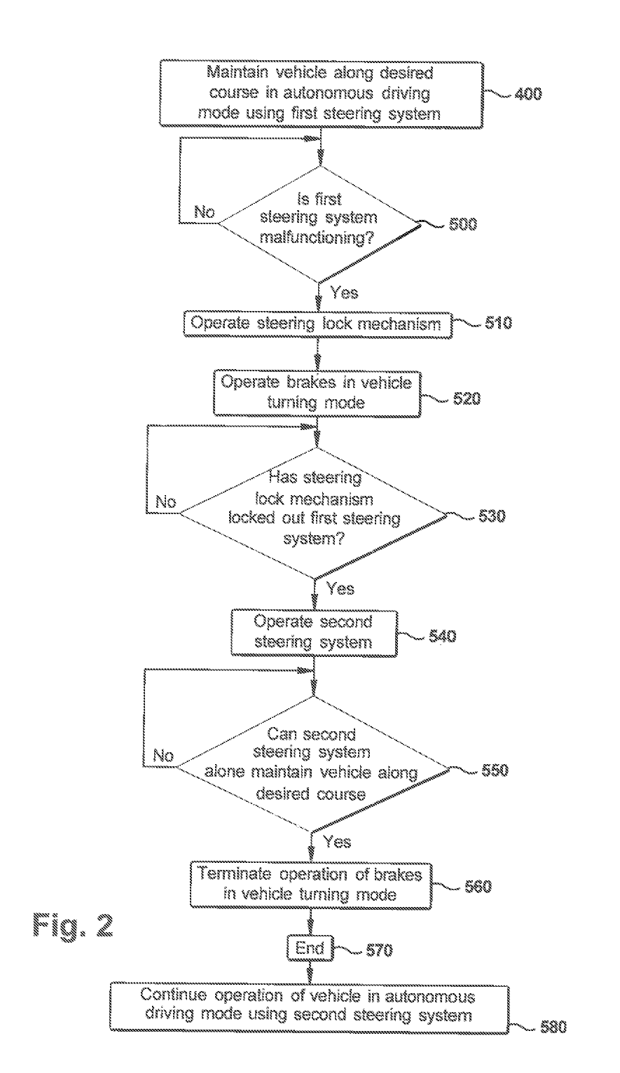

A method of controlling the vehicle is shown in FIG. 2. The method is directed at maintaining the vehicle along a desired course in the event that the first steering system 50 malfunctions.

At 400, the first steering system 50 maintains the vehicle 10 along the desired course in an autonomous driving mode. At 500 a determination is made as to whether the first steering system 50 is malfunctioning. The determination can be made, for example, by the ECU 105. As used in this specification, malfunctioning of the first steering system 50 refers to instances where the first steering system fails to maintain the vehicle 10 along the desired course. If the first steering system 50 is not malfunctioning, the method loops back to 500 to make another determination as to whether the first steering system is malfunctioning.

If the first steering system 50 is malfunctioning, the method moves to 510 and the steering lock mechanism 70 is operated to lock out the first steering system 50 to prevent turning of the front wheels 30, 35. Then, at 520 the brake controller 95 operates the brakes 75, 80, 85, 90 in the vehicle turning mode to maintain the vehicle 10 along a desired course. It is contemplated that operation of the steering lock mechanism 70 to lock out the first steering system 50 and operation of the brakes 75, 80, 85, 90 in vehicle turning mode occurs simultaneously.

Next, at 530, a determination is made as to whether the steering lock mechanism 70 has completed the process of locking out the first steering system 50. As understood by those skilled in the automotive art, it can be desirable to delay turning of the rear wheels 40, 45 until turning of the front wheels 30, 35 is prevented (i.e., the process of locking out the first steering system 50 is completed), if the process of locking out the first steering system 50 is not completed, the method loops back to 530 to make another determination as to whether the process of locking out the first steering system is completed.

If the process of locking out the first steering system 50 is completed, the method moves to 540 and the second steering system 60 is operated to maintain the vehicle 10 along a desired course. It is contemplated that the determination of whether the steering lock mechanism 70 has completed the process of locking out the first steering system 50 may be omitted, in this case, simultaneous operation of the second steering system 60 and operation of the brakes 75, 80, 85, 90 in vehicle turning mode would occur immediately after operation of the steering locking mechanism 70 to lock out the first steering system 50 simultaneously with regardless of whether the process of locking out the first steering system is completed

At 550, a determination is made as to whether operation of the second steering system 60 alone can maintain the vehicle 10 along the desired course. If the second steering system 60 alone cannot maintain the vehicle 10 along the desired course, the method loops back to 550 to make another determination as to whether operation of the second steering system alone can maintain the vehicle along the desired course. Thus, operation of the second steering system 60 and operation of the brakes 75, 80, 85, 90 in the vehicle turning mode are both responsible for maintaining the vehicle 10 along the desired course.

If the second steering system 60 alone can maintain the vehicle 10 along the desired course, the method moves to 560 and operation of the brakes 75, 80, 85, 90 in the vehicle turning mode is terminated. Thus, operation of the second steering system 60 is solely responsible for maintaining the vehicle 10 along the desired course. The method ends at 570. At 580 the vehicle 10 continuous to operate in the autonomous driving mode while the second steering system 60 maintains the vehicle along the desired course. It is contemplated that the determination as to whether operation of the second steering system 60 alone can maintain the vehicle 10 along the desired course may be omitted. In this case, in the event of first steering system 50 malfunction, maintenance of the vehicle 10 along the desired course in the autonomous driving mode after the method ending at 570 would continue by way of tandem operation of the second steering system 60 and the brakes 75, 80, 85, 90 in the vehicle turning mode.

From the above description of the invention, those skilled in the art will perceive improvements, changes and modifications. For example, an alert may be provided to an operator of the vehicle 10 that vehicle maintenance is required upon a determination that the first steering system 50 is malfunctioning. As another example, the vehicle 10 may be programmed to pull off the road and stop upon a determination that the first steering system 50 is malfunctioning. As yet another example, the autonomous driving mode may be interrupted upon a determination that the operator of the vehicle 10 has attempted to control the vehicle through the input device 55. Such improvements, changes, and modifications as those enumerated above and further improvements, changes, and modifications not specifically enumerated are within the skill of the art and are intended to be covered by the appended claims.

1. A method of operating a vehicle to maintain the vehicle along a desired course, the vehicle having a first steering system for turning left and right wheels at a first end of the vehicle, a second steering system for turning left and right wheels at a second end of the vehicle, brakes for slowing rotation of the wheels, and a steering lock mechanism, the method comprising the steps of:
determining the first steering system is malfunctioning;
operating the steering lock mechanism to lock out turning of the left and right wheels at the first end of the vehicle;
operating the brakes to maintain the vehicle along the desired course; and
operating the second steering system to maintain the vehicle along the desired course.

2. The method of claim 1, wherein the steps of operating the steering lock mechanism and operating the brakes occurs simultaneously.

3. The method of claim 1, further comprising the steps of:
determining whether the steering lock mechanism has completed locking out operation of the first steering system; and
delaying operating the second steering system until it has been determined that the steering lock mechanism has completed locking out operation of the first steering system.

4. The method of claim 1, further comprising the steps of:
determining whether operation of the second steering system alone can maintain the vehicle along the desired course; and
terminating operation of the brakes in response to a determination that operation of the second steering system alone can maintain the vehicle along the desired course.

5. The method of claim 1, wherein the step of determining the first steering system is malfunctioning includes assessing whether the vehicle is being maintained along the desired course.

6. The method of claim 1, wherein the steps of operating the steering lock mechanism and operating the brakes are performed in response to a determination that first steering system is malfunctioning.
